(19) United States
(12) Patent Application Publication
(10) Pub. No.: US 2016/0307172 A1
(43) Pub. Date: Oct. 20, 2016

(54) METHOD, APPARATUS AND SYSTEM FOR PROCESSING INFORMATION

(71) Applicant: TENCENT TECHNOLOGY (SHENZHEN) COMPANY LIMITED, Shenzhen, Guangdong (CN)

(72) Inventor: Wenbin He, Shenzhen City (CN)

(73) Assignee: TENCENT TECHNOLOGY (SHENZHEN) COMPANY LIMITED, Shenzhen, Guangdong (CN)

(21) Appl. No.: 15/101,312

(22) PCT Filed: Dec. 10, 2014
(86) PCT No.: PCT/CN2014/093431

§ 371 Date: Jun. 2, 2016

(30) Foreign Application Priority Data
Dec. 13, 2013 (CN) 201310689149.0

(51) Int. Cl. G06Q 20/10; G06Q 30/06; G06Q 40/02

(52) U.S. Cl. CPC G06Q 20/102; G06Q 40/02; G06Q 30/0631

(57) ABSTRACT

According to an example, association information of a target account is obtained. Recommendation information is generated for the target account according to the association information and is transmitted to the target account. After feedback information transmitted by the target account in response to the recommendation information is received, processing is performed according to the feedback information transmitted by the target account.

### PRIORITY STATEMENT

This application claims the benefit of Chinese Patent Application No. 201310689149.0, filed on Dec. 13, 2013, the disclosure of which is incorporated herein in its entirety by reference.

### FIELD

The present disclosure relates to computer information techniques, and more particularly, to a method, an apparatus and a system for processing information.

### BACKGROUND

Service providers usually transmit information for recommending products or services to users using a recommendation platform so as to have high reputation. At present, the recommendation platform is usually a short message platform provided by network operators. Through the short message platform, recommendations of products or services can be transmitted to users rapidly.

### SUMMARY

The following presents a simplified summary in order to provide a basic understanding of some aspects of the disclosure. The following summary merely presents some concepts of the disclosure in a simplified form as a prelude to the more detailed description below.

According to an example of the present disclosure, a method for processing information is provided. The method includes:

obtaining association information of a target account;

generating recommendation information for the target account according to the association information, and transmitting the recommendation information to the target account; and

after receiving feedback information transmitted by the target account in response to the recommendation information, performing processing according to the feedback information transmitted by the target account.

According to another example of the present disclosure, an apparatus for processing information is provided. The apparatus includes:

an obtaining module, to obtain association information of a target account;

a recommendation module, to generate recommendation information for the target account according to the association information, and transmit the recommendation information to the target account; and

a processing module, to perform processing according to feedback information after receiving the feedback information transmitted by the target account in response to the recommendation information.

According to still another example of the present disclosure, a system for processing information is provided, the system includes: a server and a client; wherein

the server is to obtain association information of a target account, generate recommendation information for the target account according to the association information, and transmit the recommendation information to the client; after receiving feedback information transmitted by the client in response to the recommendation information, perform processing according to the feedback information; and

the client is to receive the recommendation information transmitted by the server, and return the feedback information to the server.

Other aspects or embodiments of the present disclosure can be understood by those skilled in the art in light of the description, the claims, and the drawings of the present disclosure.

### BRIEF DESCRIPTION OF THE DRAWINGS

Features of the present disclosure are illustrated by way of example and not limited in the following figures, in which like numerals indicate like elements, in which:

FIG. 1 is a flowchart illustrating a method for processing information according to an example of the present disclosure;

FIG. 2 is a flowchart illustrating a method for processing information according to another example of the present disclosure;

FIG. 3 is a flowchart illustrating a method for processing information according to an example of the present disclosure;

FIG. 4 is a schematic diagram illustrating an apparatus for processing information according to an example of the present disclosure;

FIG. 5 is a schematic diagram illustrating an apparatus for processing information according to another example of the present disclosure;

FIG. 6 is a schematic diagram illustrating a recommendation module according to an example of the present disclosure;

FIG. 7 is a schematic diagram illustrating a processing module according to an example of the present disclosure;

FIG. 8 is a schematic diagram illustrating a server according to an example of the present disclosure; and

FIG. 9 is a schematic diagram illustrating a system for processing information according to an example of the present disclosure.

### DETAILED DESCRIPTION

The preset disclosure will be described in further detail hereinafter with reference to accompanying drawings and examples to make the technical solution and merits therein clearer.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Through a recommendation platform, such as a short message platform provided by network providers, service providers may transmit recommendations of products or services to users so as to have high reputation. For example, for services such as lottery ticket purchase, telephone recharge, etc., recommendation information may be transmitted to the user, reminding the user to buy a lottery ticket or recharge his telephone. After receiving the recommendation information, the user may open a corresponding website if he desires to buy a lottery ticket or recharge his telephone, and then the user may finish the payment to buy the lottery ticket or recharge the telephone. This procedure requires many operations of the user.

In one example of the present disclosure, the recommendation information is generated based on association information of the user. Thus, well-targeted recommendation information is generated for the user. After receiving the recommendation information, the user may respond the recommendation information with feedback information. According to the feedback information, the server obtains a processing instruction corresponding to the feedback information and then implements processing corresponding to the processing instruction automatically. As such, the user's operation is simplified and the recommendation becomes more intelligent.

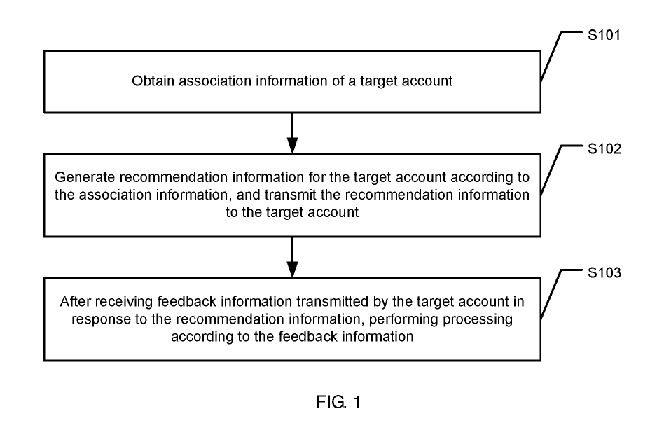

FIG. 1 is a flowchart illustrating a method for processing information according to an example of the present disclosure. As shown in FIG. 1, the method may be executed by a server. The method includes the following.

At block S101, association information of a target account is obtained.

The target account may be a user account of various kinds of instant message applications, a user account of an email box, a user account of a social networking service, a user account of a bank, etc. The association information of the target account may include any one or any combination of: a telephone number, a mail address, instant messaging application account information, social networking service account information, transaction record information, card number information and target account information, which are bound with the target account.

After the association information of the target account is obtained, it is convenient to determine information to be pushed to the target account subsequently.

At block S102, recommendation information is generated according to the association information of the target account and is transmitted to the target account.

The recommendation information may be generated for the target account according to the association information based on the services provided by a local server. For example, if the server provides lottery purchase services, it is possible to randomly (or by a designated data format) generate one or more groups of lottery numbers according to the association information of the target account which contains numbers such as cell phone number, and then recommends these lottery numbers to the user corresponding to the target account. For another example, if a cell phone number is bound with the target account, a recommendation of recharging the phone may be initiated to the user corresponding to the target account when it is detected that the balance is insufficient.

In block S102, the recommendation information may be transmitted to the target account according to a communication account bound with the target account. In one example, the communication account bound with the target account may be the target account itself, e.g., if the user finishes registration and subscription using a cell phone number, the server may directly take the target account as the bound communication account, so as to transmit the recommendation information to the communication account. The communication account bound with the target account may also be an instant messaging application account, a cell phone number, and an email address which are bound with the registered user account. The server may transmit an instant message, a short message or a multimedia message, or an email to the instant messaging application account, the cellphone number or the email address to transmit the recommendation information to the target account.

At block S103, when feedback information in response to the recommendation information is received from the target account, a processing instruction corresponding to the feedback information is executed according to the feedback information of the recommendation information.

After the feedback information is received, a processing instruction complies with a preconfigured instruction characteristic is retrieved from the feedback information through text recognition. For example, the recommendation information is asking the user to buy a lottery ticket. The feedback information of the user may be “by one lottery ticket”. At this time, a word segmentation operation is firstly performed to the feedback information. After comparison with instruction characteristic words “buy” and “one” in an instruction characteristic word library, the processing instruction of “buy” and “one” are retrieved.

In another example, when the recommendation information is transmitted in block S102, processing instructions to be selected by the user may be designated. For example, the recommendation information is asking the user to buy a lottery ticket. The recommendation information may also include the following information: “y” denotes buy; “n” denotes not buy and not receive such information later; “r” denotes change a ticket number; “5s” denotes buy 5 tickets and another 4 tickets will be sent later; “10t” denotes buy 10 times, etc. The user may select corresponding letters or figures as the feedback information to be returned to the server. Then, the server may take the letter or figure as the processing instruction.

In this example, well-targeted recommendation information may be generated for the target user according to the association information of the target user. After the recommendation information is transmitted to the user, feedback information returned by the user in response to the recommendation information may be responded automatically, which realizes automatic and intelligent recommendation, saves user's times and increases efficiency of the recommendation.

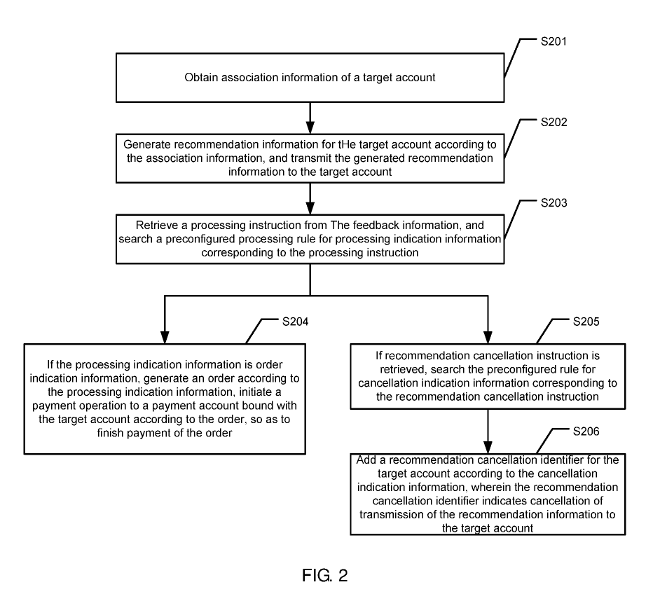

FIG. 2 shows a method for processing information according to another example of the present disclosure. This method may be applied to a server. As shown in FIG. 2, the method includes the following.

At block S201, association information of a target account is obtained. The association information of the target account may include any one or any combination of: a telephone number, a mail address, instant messaging application account information, social networking service account information, transaction record information, card number information and target account information, which are bound with the target account when the target account is registered.

At block S202, recommendation information is generated according to the association information of the target account and is transmitted to the target account.

This block may include: generating the recommendation information for the target account according to characters and/or figures in the association information, or editing characters and/or figures in the association information of the target account according to a predefined editing rule to generate the recommendation information for the target account, and transmitting the generated recommendation information to the target account.

The transmission of the generated recommendation information to the target account may include: obtaining communication attribute information of the target account, selecting one or more communication account in the communication attribute information, and transmitting the recommendation information to the selected one or more communication accounts.

The communication attribute information is one of user attribute of the target account. The communication attribute information may be a telephone number, an instant messaging number or an email address registered by the user when opening the target account. The one or more communication accounts may be selected based on the type of the recommendation information. For example, if the recommendation information is text, the telephone number, instant messaging number or the email address may be selected. If the recommendation information is voice, the telephone number may be selected.

At block S203, a processing instruction is retrieved from the feedback information, a preconfigured processing rule is searched for processing indication information corresponding to the processing instruction.

At block S204, if the processing indication information searched out is order indication information, an order is generated according to the processing indication information, and a paying operation is initiated to a payment account bound with the target account according to the generated order, so as to finish the payment operation of the order.

In one example, block S204 may include: checking whether balance of the payment account bound with the target account is not lower than the amount of payment in the order. If yes, initiating the payment operation to the payment account bound with the target account; otherwise, provide a message indicating that the balance is insufficient.

If processing indication information is obtained according to the retrieved processing instruction, an electrical order is generated directly according to processing indication information. A payment request is transmitted to a payment server by taking the payment account bound with the target account as the payer and an account of a service provider as the payee.

At block S205, if a recommendation cancellation instruction is retrieved from the feedback information, the preconfigured processing rule is searched for cancellation indication information corresponding to the recommendation cancellation instruction.

At block S206, a recommendation cancellation identifier is added to the target account according to the cancellation indication information, wherein the recommendation cancellation identifier is used for indicating to cancel to transmit the recommendation to the target account.

The preconfigured processing rule may be as described in the above example. For example, “y” denotes buy; “n” denotes not buy and not receive such information later; “r” denotes change a ticket number; “5s” denotes buy 5 tickets and another 4 tickets will be sent later; “10t” denotes buy 10 times, etc. Meanings of the letters or figures may be configured according to a practical requirement. After the processing instruction is obtained, a corresponding order may be generated according to the processing rule. For example, if the user returns a processing instruction “5s”, the server will generate the processing indication information of payment amount 10 Yuan for the target account, such that an order may be generated according to the processing indication information.

If the processing indication information is obtained according to the retrieved processing instruction, an order is generated directly according to the processing indication information. For example, according to the processing indication information indicating the fee of 10 Yuan, an electrical order with fee of 10 Yuan may be generated accordingly, wherein the payment account bound with the target account is taken as the payer and the service provider (e.g., lottery provider) account is taken as the payee.

After the payment processing of the order, the server may return a payment success message to the client, and may further return recommendation contents such as lottery number, electronic ticket, etc., or may request a recharge server to perform a recharge operation.

In this example, well-targeted recommendation information may be generated for the target user according to the association information of the target user. After the recommendation information is transmitted to the user, an order may be generated according to the feedback information returned by the user in response to the recommendation information and a payment procedure may be finished automatically, which realizes automatic and intelligent recommendation, saves user's times and increases efficiency of the recommendation.

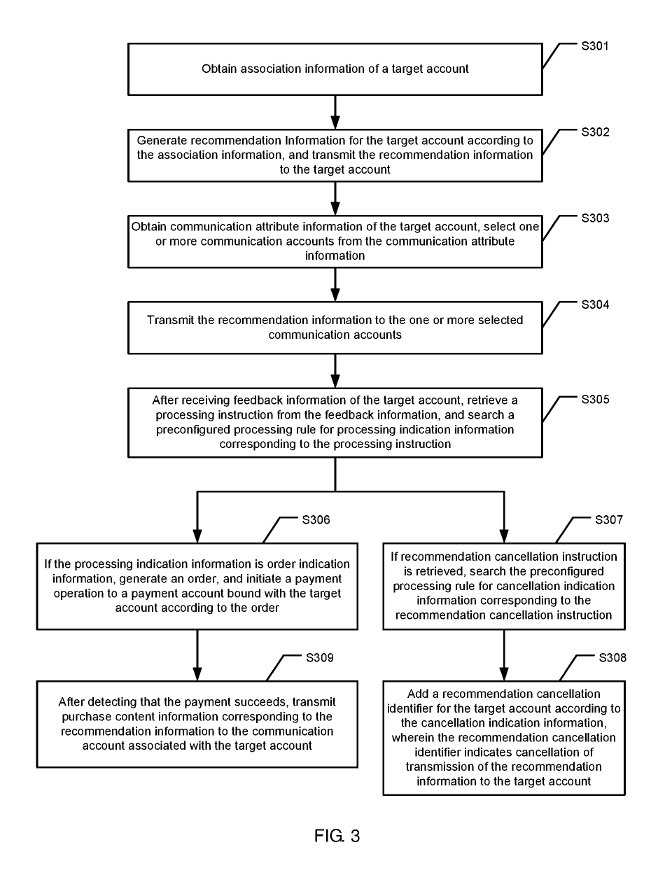

FIG. 3 is a flowchart illustrating a method for processing information according to an example of the present disclosure. As shown in FIG. 3, the method may be applied to a server. The method includes the following.

At block S301, association information of a target account is obtained. The association information of the target account may include any one or any combination of: a telephone number, a mail address, instant messaging application account information, social networking service account information, transaction record information, card number information and target account information, which are bound with the target account when the target account is registered.

At block S302, recommendation information is generated according to the association information of the target account and is transmitted to the target account.

The recommendation information may include lottery ticket purchase information, telephone recharge information or electronic ticket information, etc. The target account may include information such as user registered account or telephone number of the user who subscribed the recommendation service to the server.

At block S303, communication attribute information of the target account is obtained, and one or more communication accounts in the communication attribute information are selected.

The communication attribute information is one of user attribute of the target account. The communication attribute information may be a telephone number, an instant messaging number or an email address registered by the user when opening the target account. The one or more communication accounts may be selected based on the type of the recommendation information. For example, if the recommendation information is text, the telephone number, instant messaging number or the email address may be selected. If the recommendation information is voice, the telephone number may be selected.

At block S304, the recommendation information is transmitted to the selected one or more communication accounts.

The selected communication account is taken as a target address. The recommendation information is transmitted to a corresponding client, e.g., a cellphone with a corresponding telephone number, or a computer on which the instant messaging application account is logged.

At block S305, if feedback information in response to the recommendation information is received from the target account, a processing instruction is retrieved from the feedback information, and a preconfigured processing rule is searched for processing indication information corresponding to the processing instruction.

Corresponding to the selected communication accounts, multiple pieces of feedback information may be respectively received from the target accounts in block S305 and multiple processing instructions may be retrieved.

The processing rule is preconfigured for the target account by the server. With respect to different contents of the recommendation information, there may be different rules. For each kind of recommendation information, the processing rule generally includes a purchase processing instruction and a recommendation cancellation instruction. The processing indication information configured for the purchase processing instruction in the preconfigured processing rule includes order indication information. The processing indication information configured for the recommendation cancellation instruction includes cancellation indication information.

When the user confirms to buy or receive a corresponding product or service, the order indication information used for generating different orders is configured in the processing rule. When the user does not need or want to subscribe to a particular kind of recommendation information, e.g., does not want to receive lottery recommendation information, information used for indicating recommendation cancellation is configured in the processing rule.

Block S305 may include: receiving the feedback information returned in response to the recommendation information, retrieving a processing instruction carried in the feedback information; if a purchase processing instruction is retrieved, searching the preconfigured rule for order indication information corresponding to the retrieved purchase processing instruction; if a purchase confirm instruction is retrieved, executing block S306; if recommendation cancellation instruction is retrieved, executing block S307 and S308.

Block S306, if the processing indication information is order indication information, an order is generated according to the processing indication information, and a payment operation is initiated to a payment account bound with the target account according to the generated order, so as to finish the payment processing of the order. Then, block S309 is executed.

In one example of the present disclosure, block S306 may include: if the processing indication information searched out is order indication information, generating an order according to the order indication information; determining whether the payment account bound with the target account have a balance not lower than the payment amount in the order; if yes, initiating the payment operation to the payment account bound with the target account; otherwise, providing a prompt message indicating that the balance is insufficient. If processing indication information is obtained according to the retrieved processing instruction, an electronic order is directly generated according to the processing indication information, and a payment request is initiated to a corresponding payment server taking the payment account bound with the target account as a payer and the corresponding service provider account as a payee.

At block S307, if a recommendation cancellation instruction is retrieved, the preconfigured processing rule is searched to obtain cancellation indication information corresponding to the recommendation cancellation instruction.

At block S308, a recommendation cancellation identifier is added to the target account according to the cancellation indication information, wherein the recommendation cancellation identifier is used for indicating that the transmission of recommendation information to the target account is cancelled.

After the cancellation identifier is added to the target account, the server does not perform an order processing to the target account when detecting recommendation information.

At block S309, after the payment operation succeeds, purchase content information corresponding to the recommendation information is transmitted to the communication account associated with the target account.

After the payment processing of the order is finished, the server may further return a message to the client indicating that the payment succeeds, and may further return recommendation contents such as lottery number, electronic ticket, etc., or directly request a recharge server to perform a telephone recharge operation.

In this example, well-targeted recommendation information may be generated for the target user according to the association information of the target user. After the recommendation information is transmitted to the user, an order may be generated according to the feedback information returned by the user in response to the recommendation information and a payment procedure may be finished automatically, which realizes automatic and intelligent recommendation, saves user's times and increases efficiency of the recommendation.

Hereinafter, an information processing apparatus and an information processing system are described.

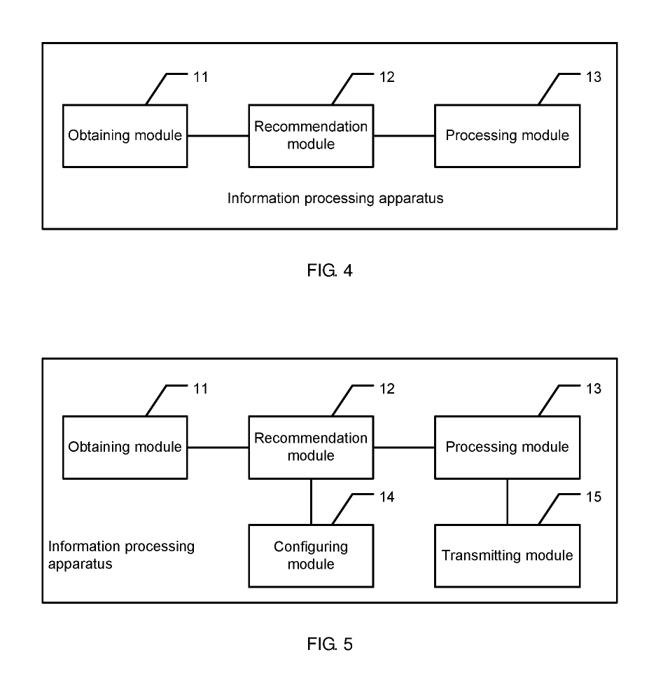

FIG. 4 is a schematic diagram illustrating an information processing apparatus according to an example of the present disclosure. The information processing apparatus may be configured in a server. As shown in FIG. 4, the apparatus 400 includes:
an obtaining module 11, to obtain association information of a target account; wherein the association information includes any one or any combination of: a telephone number, a mail address, instant messaging application account information, social networking service account information, transaction record information, card number information and target account information, which are bound with the target account;
a recommendation module 12, to generate recommendation information according to the association information of the target account, and transmit the recommendation information to the target account; and
a processing module 13, to perform processing corresponding to the feedback information after receiving feedback information transmitted by the target account in response to the recommendation information.

The target account may be a user account of various kinds of instant message applications, a user account of an email box, a user account of a social networking service, a user account of a bank, etc. The association information of the target account may include any one or any combination of: a telephone number, a mail address, instant messaging application account information, social networking service account information, transaction record information, card number information and target account information, which are bound with the target account.

The recommendation information is generated by the recommendation module 12 based on services provided by the server for the target account and its association information. For example, if the server provides lottery purchase service, the recommendation module 12 may generate randomly (or in a designated format) a group or several groups of lottery numbers according to the association information such as telephone number of the target account, and recommend these lottery numbers to the target account. For another example, in case that the target account is bound with a telephone number, the recommendation module 12 may transmit a telephone recharge recommendation to the target account when detecting that the balance of the telephone is insufficient.

The recommendation module 12 may transmit the recommendation information to the target account according to the communication account bound with the target account. For example, the communication account bound with the target account may be the target account itself, e.g., if the user finishes registration and subscription using a cell phone number, the server may directly take the target account as the bound communication account, so as to transmit the recommendation information to the communication account. The communication account bound with the target account may also be an instant messaging application account, a cell phone number, and an email address which are bound with the registered user account. The server may transmit an instant message, a short message or a multimedia message, or an email to the instant messaging application account, the cellphone number or the email address to transmit the recommendation information to the target account.

After receiving the feedback information, the processing module 13 may retrieve a processing instruction conforming to the preconfigured instruction characteristics from the feedback information through text recognition.

In one example, the recommendation module 12 may designate processing instructions to be used by the user when replying to the recommendation information. For example, “y” denotes buy; “n” denotes not buy and not receive such information later; “r” denotes change a ticket number; “5s” denotes buy 5 tickets and another 4 tickets will be sent later; “10t” denotes buy 10 times, etc. The user may select corresponding letters or figures as the feedback information to be returned to the server. Then, the processing module 13 of the server may take the letter or figure as the processing instruction.

The processing module 13 may generate a corresponding order according to the retrieved processing instruction and the processing rule. For example, if the user returns a processing instruction “5s”, the processing module 12 generates processing indication information of a fee of 10 Yuan for the target account, such that the payment unit 13 generates an order according to the processing indication information.

In this example, well-targeted recommendation information may be generated for the target user according to the association information of the target user. After the recommendation information is transmitted to the user, an order may be generated according to the feedback information returned by the user in response to the recommendation information and a payment procedure may be finished automatically, which realizes automatic and intelligent recommendation, saves user's times and increases efficiency of the recommendation.

FIG. 5 is a schematic diagram illustrating an information processing apparatus according to another example of the present disclosure. As shown in FIG. 5, the information processing apparatus includes an obtaining module 11, a recommendation module 12, a processing module 13 and a configuring module 14.

Functions of the obtaining module 11, the recommendation module 12 and the processing module 13 in the information processing apparatus 500 are similar to the corresponding modules in the information processing apparatus 400 as shown in FIG. 4.

The configuring module 14 configures the processing rule for the target account in advance; wherein the preconfigured processing rule includes a purchase processing instruction and a recommendation cancellation instruction, the processing indication information configured for the purchase processing instruction in the preconfigured processing rule includes order indication information, and the processing instruction configured for the recommendation cancellation instruction includes cancellation indication information.

After the payment processing of the order is finished, the server may return a payment success message to the client, and may further return recommendation contents such as lottery number, electronic ticket, etc., or may request a recharge server to perform a recharge operation.

The information processing apparatus 500 may further include a transmitting module 15, configured to transmit purchase content information corresponding to the recommendation information according to the communication account associated with the target account after detecting that the payment operation succeeds.

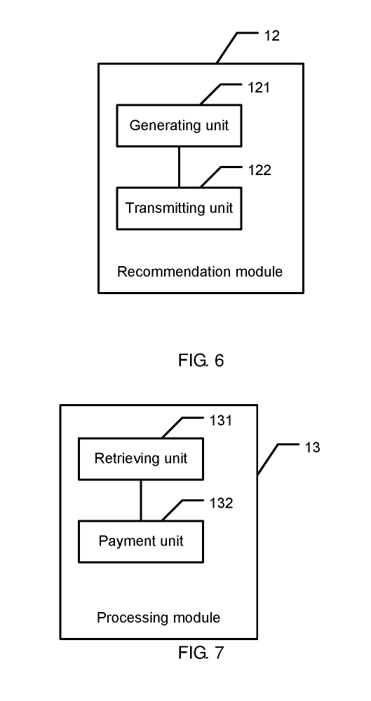

In one example, as shown in FIG. 6, the recommendation module 12 may include:
a generating unit 121, to generate the recommendation information for the target account according to characters and/or figures in the association information of the target account, or edit the characters and/or figures in the association information of the target account according to a preconfigured editing rule to generate the recommendation information for the target account; and
a transmitting unit 122, to transmit the generated recommendation information to the target account.

In one example, the transmitting unit 122 is to obtain communication attribute information of the target account, select one or more communication accounts in the communication attribute information, and transmit the recommendation information to the selected one or more communication accounts.

The communication attribute information is one of user attribute of the target account. The communication attribute information may be a telephone number, an instant messaging number or an email address registered by the user when opening the target account. The one or more communication accounts may be selected based on the type of the recommendation information. For example, if the recommendation information is text, the telephone number, instant messaging number or the email address may be selected. If the recommendation information is voice, the telephone number may be selected.

As shown in FIG. 7, the processing module 13 may include:
a retrieving unit 131, to retrieve the processing instruction from the feedback information after the feedback information transmitted by the target account in response to the recommendation information is received, and search a preconfigured processing rule for processing indication information corresponding to the processing instruction; and
a payment unit 132, to generate an order according to the processing indication information if the processing indication information searched out is order indication information, and initiate a payment operation to the payment account bound with the target account according to the generated order, so as to finish payment processing of the order.

If the retrieving unit 131 retrieves a purchase processing instruction from the feedback information, the retrieving unit 131 searches the preconfigured processing rule for order indication information corresponding to the retrieved purchase processing instruction.

If the retrieving unit 131 retrieves a recommendation cancellation instruction from the feedback information, the retrieving unit 131 searches the preconfigured processing rule for cancellation indication information corresponding to the recommendation cancellation instruction, and adds a recommendation cancellation identifier to the target account according to the cancellation indication information, wherein the recommendation cancellation identifier is to indicate that transmission of the recommendation information to the target account is cancelled.

In one example, the payment unit 132 generates an order according to the order indication information if the processing indication information searched out is order indication information, determines whether the balance of the payment account bound with the target account is not lower than the payment account of the order, if yes, initiates the payment operation to the payment account bound with the target account; and provides a prompt message indicating that the balance is insufficient if otherwise.

It should be noted that, the detailed implementation of the above modules and units may refer to descriptions corresponding to the FIG. 1 to FIG. 3.

The various modules and/or functions described above may be implemented by executing the above described machine-readable instructions on a processor.

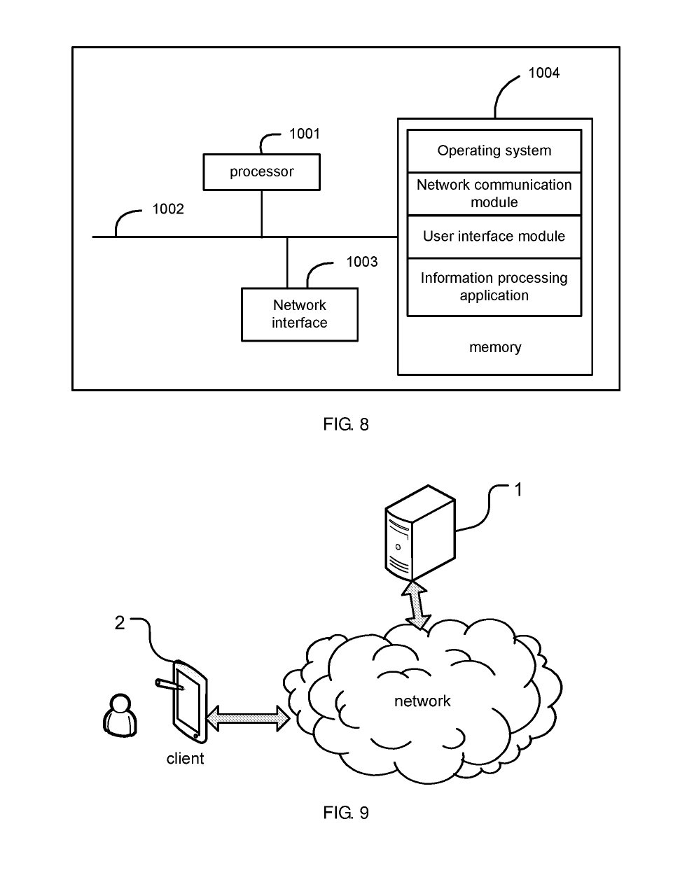

FIG. 8 shows a structure of a server according to an example of the present disclosure. As shown in FIG. 8, the server includes a processor 1001, a communication bus 1002, a network interface 1003, and a memory 1004.

The processor 1001 may include one or more processors for executing the sets of instructions stored in the memory. The processor is a hardware device, such as a central processing unit (CPU) or a micro controlling unit (MCU).

The communication bus 1002 is to implement communications between other components.

The network interface 1003 may be a wired interface, a wireless interface (such as Wi-Fi, mobile communication interface, etc.).

The memory 1004 is a non-transitory processor-readable storage media, such as a RAM memory, flash memory, ROM memory, EPROM memory, EEPROM memory, registers, hard disk, a removable disk, a CD-ROM, or any other form of non-transitory storage medium known in the art. The memory 1004 may also be a remote storage apparatus for the processor 1001.

As shown in FIG. 8, the memory 1004, as a computer readable storage medium, stores an operating system, a network communication module, and an information processing application and other applications.

The processor 1001 may execute the information processing application stored in the memory 1004 to perform the following acts:
obtaining association information of a target account;
generating recommendation information for the target account according to the association information, and transmitting the recommendation information to the target account;
after receiving feedback information transmitted by the target account in response to the recommendation information, executing a processing instruction corresponding to the feedback information according to the feedback information transmitted by the target account.

The association information includes any one or any combination of: a telephone number, a mail address, instant messaging application account information, social networking service account information, transaction record information, card number information and target account information, which are bound with the target account.

FIG. 9 is a schematic diagram illustrating an information processing system according to an example of the present disclosure. As shown in FIG. 9, the system includes a server 1 and a client 2.

The server 1 obtains association information of a target account, generates recommendation information for the target account according to the association information, and transmits the recommendation information to the target account, after receiving feedback information transmitted by the client 2 in response to the recommendation information, executes a processing instruction corresponding to the feedback information.

The client 2 receives the recommendation information transmitted by the server 1, and returns the response message to the server 1 in response to the recommendation information.

The recommendation information may include lottery ticket purchase information, telephone recharge information or electronic ticket information, etc.

After the payment processing of the order, the server may return a payment success message to the client, and may further return recommendation contents such as lottery number, electronic ticket, etc., or may request a recharge server to perform a recharge operation.

In examples of the present disclosure, the server 1 represents a computer system that is made available to the client 2 via the network. Various hardware components (not shown in FIG. 9) such as external monitors, keyboards, mice, tablets, hard disk drives, magnetic tapes, and other devices may be used in conjunction with server 1.

The server 1 may include an instant messaging server (not shown) for providing instant messaging services to the client 2. The server 1 may also include a service providing server (e.g., a lottery website server, not shown in FIG. 9) connected with the instant messaging server for providing services to the client 2 through instant messages.

The client 2 may be a smartphone, a Personal Digital Assistant, a desktop computer or a laptop computer. Additionally, other devices such as netbooks, handheld and palmtop devices may also be deployed as the client 2.

In this example, well-targeted recommendation information may be generated for the target user according to the association information of the target user. After the recommendation information is transmitted to the user, an order may be generated according to the feedback information returned by the user in response to the recommendation information and a payment procedure may be finished automatically, which realizes automatic and intelligent recommendation, saves user's times and increases efficiency of the recommendation.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

1. (canceled)

2. (canceled)

3. A method for processing information, comprising:
obtaining association information of a target account;
generating recommendation information for the target account according to the association information, and transmitting the recommendation information to the target account;
after receiving feedback information transmitted by the target account in response to the recommendation information, performing processing according to the feedback information transmitted by the target account,
wherein the generating the recommendation information for the target account according to the association information and transmitting the recommendation information to the target account comprises:
generating the recommendation information for the target account according to characters and/or figures contained in the association information of the target account, or editing characters and/or figures contained in the association information of the target account according to a preconfigured editing rule to generate the recommendation information for the target account; and
transmitting the generating recommendation information to the target account.

4. The method of claim 3, wherein the transmitting the generated recommendation information to the target account comprises:
obtaining communication attribute information of the target account, and selecting one or more communication accounts in the communication attribute information; and
transmitting the recommendation information to the one or more selected communication accounts.

5. The method of claim 3, wherein the performing processing according to the feedback information transmitted by the target account after receiving the feedback information transmitted by the target account in response to the recommendation information comprises:
after receiving the feedback information transmitted by the target account in response to the recommendation information, retrieving a processing instruction from the feedback information, and searching a preconfigured processing rule for processing indication information corresponding to the processing instruction;
if the processing indication information searched out is order indication information, generating an order according to the processing indication information, and initiating a payment operation to a payment account bound with the target account according to the order to finish payment processing of the order.

6. The method of claim 5, further comprising:
before obtaining the association information of the target account, configuring the processing rule;
wherein the preconfigured rule comprises a purchase processing instruction and a recommendation cancellation instruction, processing indication information configured for the purchase processing instruction in the processing rule comprises the order indication information; and the processing indication information configured for the recommendation cancellation instruction in the processing rule comprises cancellation indication information.

7. The method of claim 6, wherein the retrieving the processing instruction from the feedback information and searching the preconfigured processing rule for the processing indication information corresponding to the processing instruction comprises:
receiving the feedback information transmitted by the target account in response to the recommendation information, and retrieving the processing instruction from the feedback information;
if the purchase processing instruction is retrieved, searching the preconfigured processing rule for order indication information corresponding to the purchase processing instruction.

8. The method of claim 7, further comprising:
if the recommendation cancellation instruction is retrieved, searching the preconfigured processing rule for cancellation indication information corresponding to the recommendation cancellation instruction; and
adding a recommendation cancellation identifier for the target account according to the cancellation indication information, wherein the recommendation cancellation identifier is used for indicating cancellation of transmission of the recommendation information to the target account.

9. The method of claim 5, wherein if the processing indication information searched out is order indication information, generating an order according to the processing indication information, and initiating a payment operation to a payment account bound with the target account according to the order to finish payment processing of the order comprises:
if the processing indication information searched out is order indication information, generating the order according to the processing indication information;
determining whether a balance of the payment account bound with the target account is not lower than a payment account of the order;
if yes, initiating the payment operation to the payment account bound with the target account;
otherwise, providing a message indicating that the balance is insufficient.

10. The method of claim 9, further comprising:
after detecting that the payment succeeds, transmitting purchase content information corresponding to the recommendation information to the target account.

11. (canceled)

12. An apparatus for processing information, comprising:
an obtaining module, to obtain association information of a target account;
a recommendation module, to generate recommendation information for the target account according to the association information, and transmit the recommendation information to the target account; and
a processing module, to perform processing according to feedback information after receiving the feedback information transmitted by the target account in response to the recommendation information,
wherein the recommendation information comprises:
a generating unit, to generate the recommendation information for the target account according to characters and/or figures contained in the association information of the target account, or edit characters and/or figures contained in the association information of the target account according to a preconfigured editing rule to generate the recommendation information for the target account; and
a transmitting unit, to transmit the generated recommendation information to the target account.

13. The apparatus of claim 12, wherein the transmitting unit is to obtain communication attribute information of the target account, and select one or more communication accounts from the communication attribute information, and transmit the recommendation information to the one or more selected communication accounts.

14. The apparatus of claim 12, wherein the processing module comprises:
a retrieving unit, to retrieve a processing instruction from the feedback information after the feedback information transmitted by the target account in response to the recommendation information is received, and search a preconfigured processing rule for processing indication information corresponding to the processing instruction; and
a payment unit, to generate an order according to the processing indication information if the processing indication information is order indication information, and initiate a payment operation to a payment account bound with the target account according to the generated order so as to finish payment processing of the order.

15. The apparatus of claim 14, further comprising:
a configuring module, to configured the processing rule for the target account;
wherein the preconfigured rule comprises a purchase processing instruction and a recommendation cancellation instruction, processing indication information configured for the purchase processing instruction in the processing rule comprises the order indication information; and the processing indication information configured for the recommendation cancellation instruction in the processing rule comprises cancellation indication information.

16. The apparatus of claim 15, wherein the retrieving unit is to receive the feedback information, retrieve the processing instruction from the feedback information, if the purchase processing instruction is retrieved, search the preconfigured processing rule for the order indication information corresponding to the purchase processing instruction.

17. The apparatus of claim 16, wherein the retrieving unit is to, if the recommendation cancellation instruction is retrieved, search the preconfigured processing rule for the cancellation indication information corresponding to the recommendation cancellation instruction, and add a recommendation cancellation identifier for the target account according to the cancellation indication information, wherein the recommendation cancellation identifier is used for indicating cancellation of transmission of the recommendation information to the target account.

18. The apparatus of claim 14, wherein the payment unit is to, if the processing indicating information is order indication information, generate the order according to the order indication information, determine whether a balance of the payment account bound with the target account is not lower than a payment amount of the order, initiate the payment operation if the balance is not lower than the payment amount, and provide a message indicating that the balance is insufficient if otherwise.

19. The apparatus of claim 18, further comprising:
a transmitting module, to transmit purchase content information corresponding to the recommendation information to a communication account associated with the target account after it is detected that the payment succeeds.

20. A system for processing information, comprising: a server and a client; wherein
the server is to obtain association information of a target account, generate recommendation information for the target account according to the association information, and transmit the recommendation information to the client; after receiving feedback information transmitted by the client in response to the recommendation information, perform processing according to the feedback information; and
the client is to receive the recommendation information transmitted by the server, and return the feedback information to the server;
wherein the server is further to generate the recommendation information for the target account according to characters and/or figures contained in the association information of the target account, or edit characters and/or figures contained in the association information of the target account according to a preconfigured editing rule to generate the recommendation information for the target account, and transmit the generated recommendation information to the target account.
